(19) United States
(12) Patent Application Publication
(10) Pub. No.: US 2016/0114898 A1
(43) Pub. Date: Apr. 28, 2016

(54) CIRCUIT FOR DE-ICING AN AIR INLET LIP OF AN AIRCRAFT PROPULSION ASSEMBLY

(71) Applicant: SNECMA, Paris (FR)

(72) Inventors: Nuria Llamas Castro, Savigny Sur Orge (ES); Thomas Julien Nguyen Van, Alfortville (FR); Bruna Manuela Ramos, Seine-Port (FR)

(21) Appl. No.: 14/923,214

(22) Filed: Oct. 26, 2015

(30) Foreign Application Priority Data
Oct. 27, 2014 (FR) 1460330

(51) Int. Cl. B64D 33/02; F02C 7/047

(52) U.S. Cl. CPC B64D 33/02; F02C 7/047; B64D 2033/0233

(57) ABSTRACT

Propulsion assembly, comprising a turbine engine surrounded by a nacelle comprising an annular air inlet lip, the propulsion assembly further comprising a circuit for lubricating elements of the turbine engine and a circuit for de-icing the air inlet lip, characterised in that said de-icing circuit comprises a heat exchanger comprising a primary circuit of oil supplied by said lubrication circuit and a secondary circuit of a heat transfer fluid for supplying at least one de-icing channel extending into said air inlet lip, said de-icing circuit further comprising a pump for circulating the heat transfer fluid into said at least one channel.

### TECHNICAL FIELD

The present invention relates to a circuit for de-icing an air inlet lip of a propulsion assembly, in particular of an aircraft, and more precisely to a propulsion assembly comprising such a circuit.

### PRIOR ART

The prior art comprises in particular FR-A1-2,987,602 and GB-A-2,314,887.

A propulsion assembly comprises an engine of the turbine engine type which is surrounded by a nacelle, said nacelle comprising an annular air inlet lip in particular in the engine.

When the turbine engine is a bypass turbojet engine, the air flow which passes into the air inlet lip passes through fan blading and then divides into a primary air flow which enters the turbine engine and a secondary air flow which flows around the turbine engine.

When the turbine engine is a turboprop engine, for example of the open rotor pusher type (i.e. the pusher propellers of which are located downstream of the turbine engine, relative to the direction of flow of the air around said turbine engine), all of the air flow which passes into the air inlet lip powers the turbine engine.

It is understood that the present invention applies not only to the above-mentioned examples of turbine engines, but also to any type of turbine engine design which has a nacelle comprising an air inlet which requires a de-icing function.

The role of the air inlet lip on a propulsion assembly is thus to make it possible to supply air to the engine, over the entire operating range thereof, whilst minimising losses and drag. However, an air inlet lip is in direct contact with the external environment of the propulsion assembly and is subjected to external stresses, such as in particular icing. The formation of ice on the air inlet lip can cause in particular a reduction in the efficiency thereof and the detachment of sheets of ice which, when passing into the air inlet, pose a risk of damage to the engine and in particular to the fan blading or to the propellers.

In order to limit the icing phenomena on the air inlet lip of a propulsion assembly, an NAI (nacelle anti icing) system for de-icing the lip is used. Conventionally, this is a hot air bleed system for heating the outer surface of the air inlet lip.

In the current art, the de-icing air is bled in the region of a high-pressure (HP) compressor of the turbine engine and then transported by a channel to de-icing ducts extending in the region of the air inlet lip.

In terms of performance, said de-icing function using hot air translates into the need for bleeding air at the HP compressor, leading to a loss of rate of flow of air worked for the engine and thus to a loss in performance of the engine.

The applicant has already proposed a solution to this problem in FR-A1-3,001,253, which describes a system in which the lubrication oil of the engine circulates in the air inlet lip of the nacelle for the purpose of the de-icing thereof.

The present invention makes it possible to remedy the above-mentioned problem and to propose an improvement to the preceding solution, in a simple, effective and economical manner.

### SUMMARY OF THE INVENTION

For this purpose, the invention proposes a propulsion assembly comprising a turbine engine surrounded by a nacelle comprising an annular air inlet lip, the propulsion assembly further comprising a circuit for lubricating elements of the turbine engine and a circuit for de-icing the air inlet lip, characterised in that said de-icing circuit comprises a heat exchanger comprising two superimposed heat exchange modules, including:
a first heat exchange module comprising a primary circuit of oil supplied by said lubrication circuit and a secondary circuit of a heat transfer fluid for supplying at least one de-icing channel extending into said air inlet lip, said de-icing circuit further comprising a pump for circulating the heat transfer fluid into said at least one de-icing channel,
and a second heat exchange module of the surface type and comprising an outer surface which is intended to be swept by a flow of cooling air.

The invention thus proposes de-icing the air inlet lip by means of a heat transfer fluid which is heated by the lubrication oil of the engine. Firstly, this makes it possible to reduce the loss in pressure related to the bleeding of air at the engine required in the prior art to ensure the de-icing function. Secondly, this allows heat exchanges which promote the cooling of the lubrication oil, which can be very hot after it has lubricated elements of the engine such as bearings or equipment. Said heat exchanges are ensured by means of the heat exchanger. The advantage of using a heat transfer fluid having a calorific value which is greater than that of air is that it allows improved heat exchanges and makes it possible to thus limit the requirement in terms of exchange surface. The heat transfer fluid is chosen so as to have heat exchange characteristics which are greater than those of air or even equal to those of oil, allowing greater heat dissipation than by means of a simple air/oil heat exchange.

Furthermore, the invention makes it possible to solve secondary problems which directly influence the performance of the propulsion assembly. It involves for example:
improving the aerodynamic lines of the nacelle, because said nacelle can have fewer scoops for bleeding air from the external flow in order to cool the oil of the heat exchangers,
reducing the mass of the external configuration of the engine: it is indeed possible to reduce or even eliminate some of the systems by coupling functions, and
reducing the quantity of heat exchanges between the fluids, thus the amount of loss.

The de-icing circuit is not necessarily intended to ensure the de-icing of the air inlet lip by itself. The primary function sought can be that of allowing cooling of the oil, the consequence of which is heating of the air inlet lip. The heat exchanges can be designed in such a way that said heating is not necessarily sufficient to ensure de-icing. An auxiliary, for example electric, de-icing system, can be provided to assist the de-icing circuit according to the invention and to allow the de-icing of the air inlet lip in all cases.

The propulsion assembly according to the invention may have one or more of the features below, taken in isolation or in combination with one another:
the channel(s) is/are integrated in the lip,
the lip comprises two skins which are superimposed and define said at least one channel therebetween,
one of the skins defines an external surface of the lip,
the skins define a single channel therebetween, which channel has a relatively small thickness and is designed to ensure the circulation of a film of heat transfer fluid,
the skins define a plurality of independent channels therebetween, which channels are each designed to ensure the circulation of heat transfer fluid,
one of the skins comprises hollow portions which are closed by the other of the skins to define said channels,
the lip is fixed to the rest of the nacelle by detachable fixing means, for example of the screw and nut type,
said at least one channel has a general annular shape and is divided into sectors, each channel sector preferably being connected to an inlet and to an outlet of heat transfer fluid, which are independent of the inlets and outlets of heat transfer fluid of the other channel sectors,
the fluid inputs of the channel sectors are connected to the pump by valves,
the heat exchanger is coupled to a surface exchanger, an outer surface of which, comprising for example fins, is intended to be swept by a flow of cooling air,
the surface exchanger comprises an oil circuit which is coupled to the oil circuit of the heat exchanger,
the coupling is produced by means of a valve,
the valve is connected to control means which are designed to control the valve according to in particular the temperature of the oil (for example in the oil circuit of the heat exchanger) and/or the air flow, and
the control means are connected to at least one sensor for measuring the temperature of the oil and/or the air flow.
said first module comprises a first fluid circulation chamber, which is part of the secondary fluid circuit, and wherein oil circulation manifolds extend, which are part of the primary oil circuit,
said second module comprises a second oil circulation chamber which is inserted between said first chamber and said outer surface,
said outer surface comprises projecting fins which are intended to increase the surface areas for heat exchange with said air flow,
said manifolds are independent of said second chamber,
a bypass system connects the manifolds and said second chamber,
said bypass system comprises a valve,
said valve is a thermostatic valve, and
said thermostatic valve is designed to open the bypass when the temperature of the oil exceeds a specific threshold.

### DESCRIPTION OF THE DRAWINGS

The invention will be better understood, and other details, features and advantages of the invention will become clearer upon reading the following description, given by way of non-limiting example with reference to the accompanying drawings, in which:

FIG. 1 is a schematic, axial sectional view of a propulsion assembly,

FIG. 2 is a very schematic, axial sectional view of a propulsion assembly according to the invention,

FIGS. 3a, 3b and 3c are schematic axial sectional half views of an air inlet lip of a propulsion assembly according to variants of the invention,

FIG. 4 is a schematic front and cross-sectional view of an air inlet lip of a propulsion assembly according to the invention,

FIG. 5 is another schematic partial view of a heat transfer fluid circuit for a propulsion assembly according to the invention, and

FIG. 6 is a schematic, sectional view of a heat exchanger for a propulsion assembly according to the invention.

### DETAILED DESCRIPTION

A propulsion assembly 10 comprises an engine or a turbine engine which is surrounded by a nacelle.

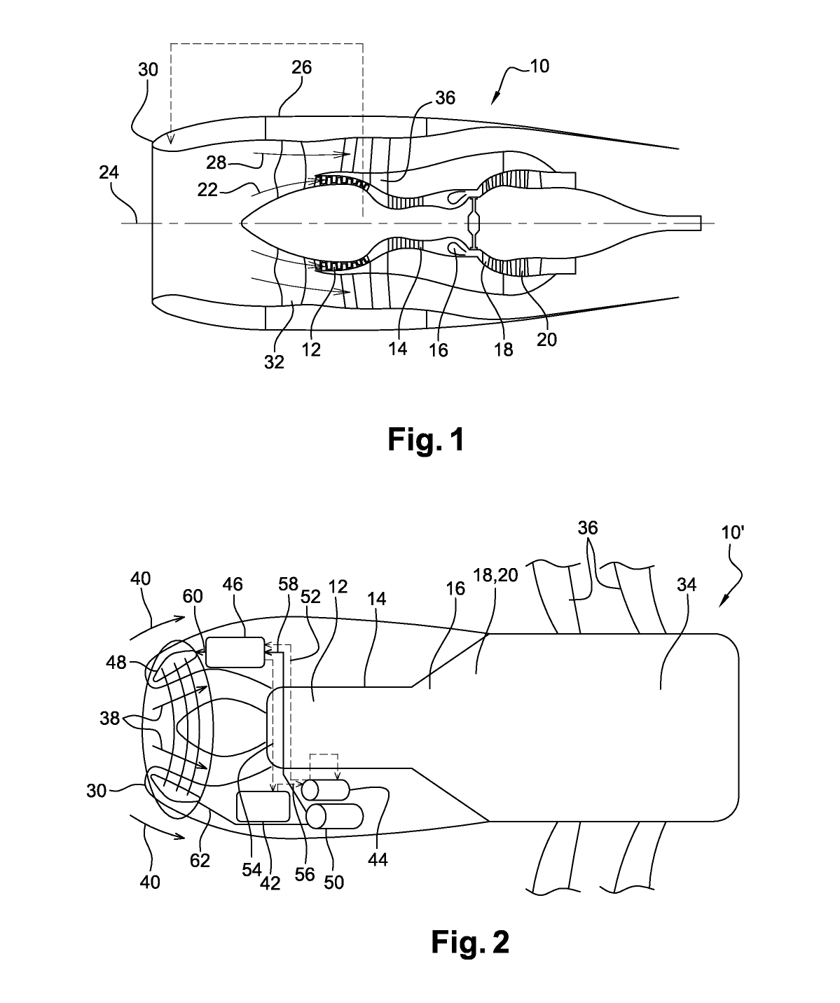

With reference to FIG. 1, the turbine engine is a bypass turbojet engine which comprises, from upstream to downstream in the direction of flow of the gases, a low-pressure compressor 12, a high-pressure compressor 14, a combustion chamber 16, a high-pressure turbine 18 and a low-pressure turbine 20, which define a stream of flow of a primary flow of gas 22.

The rotor of the high-pressure turbine 18 is rigidly connected to the rotor of the high-pressure compressor 14 so as to form a high-pressure body, whereas the rotor of the low-pressure turbine 20 is rigidly connected to the rotor of the low-pressure compressor 12 so as to form a low-pressure body. The rotor of each turbine rotates the rotor of the associated compressor about an axis 24 as a result of the thrust of the gases coming from the combustion chamber 16.

The nacelle 26 extends around the turbine engine and defines an annular stream of flow of a secondary flow 28 around said turbine engine. The upstream end of the nacelle 26 defines an annular air inlet lip 30 which an air flow enters, which air flow passes through a fan 32 of the turbine engine so as to then divide and form the above-mentioned primary 22 and secondary 28 flows.

In the prior art shown in FIG. 1, the air inlet lip 30 is de-iced by means of a de-icing circuit (shown schematically by dotted lines) by circulating compressed air bled from the engine or lubrication oil of the engine in the air inlet lip.

The present invention proposes an advantageous improvement to said technologies, the general principle of which is shown schematically in FIG. 2.

Although the turbine engine shown in FIG. 2 is a turboprop engine, said FIG. 2 shows a specific example of an application of the invention which can of course be applied to other types of turbine engine, such as the bypass turbojet engine from FIG. 1.

The turboprop engine from FIG. 2 comprises, in addition to the low-pressure compressor 12, the high-pressure compressor 14, the combustion chamber 16, the high-pressure turbine 18 and the low-pressure turbine 20 described above, a power turbine 34 which drives two coaxial, unshrouded and generally contra-rotating propellers 36.

The propellers 36 extend radially towards the outside of the nacelle 26 with respect to the longitudinal axis of the turbine engine. The upstream end of the nacelle 26 defines an annular air inlet lip 30 which an air flow 38 enters, said air flow being intended to enter the engine. The air flow 40 which flows outside the nacelle 26 is intended to pass through the propellers 36.

In a known manner, the propulsion assembly 10′ comprises a circuit for lubricating elements of the engine, which typically comprises a lubrication oil tank 42, ducts, and a pump 44 for circulating the oil in said ducts. Said lubrication circuit makes it possible for example to supply oil to bearing lubrication chambers.

The propulsion assembly 10′ further comprises a circuit for de-icing the air inlet lip 30. According to the invention, said de-icing circuit comprises a heat exchanger 46 comprising a primary circuit of oil supplied by said lubrication circuit and a secondary circuit of a heat transfer fluid for supplying at least one de-icing channel 48 extending into said air inlet lip, said de-icing circuit further comprising a pump 50 for circulating the heat transfer fluid into the channel(s).

Each circuit of the exchanger 46 comprises a fluid inlet and outlet. The primary (oil) circuit of the exchanger 46 comprises an inlet connected by a duct 52 to the pump 44 and an outlet connected by a duct 54 to the tank 42, which itself is connected to the pump 44 by another duct 56. The exchanger 46 is thus installed between the tank 42 and the pump 44 in such a way that the oil, which is quite hot, is cooled in the exchanger 46 before being transported back towards the tank 42.

The secondary (heat transfer fluid) circuit of the exchanger 46 comprises an inlet connected by an inlet duct 58 to the pump 50 and an outlet connected by an outlet duct 60 to the de-icing channel(s) 48, which itself or themselves is/are connected to the pump 50 by another duct 62. The heat transfer fluid is thus heated by the oil in the exchanger 46 before being transported towards the de-icing channel(s) 48. The secondary circuit is a closed circuit which is filled with the heat transfer fluid and optionally connected to a tank of said fluid.

The or each de-icing channel 48 is preferably annular and extends into the lip 30, preferably over the entire circumferential extent thereof.

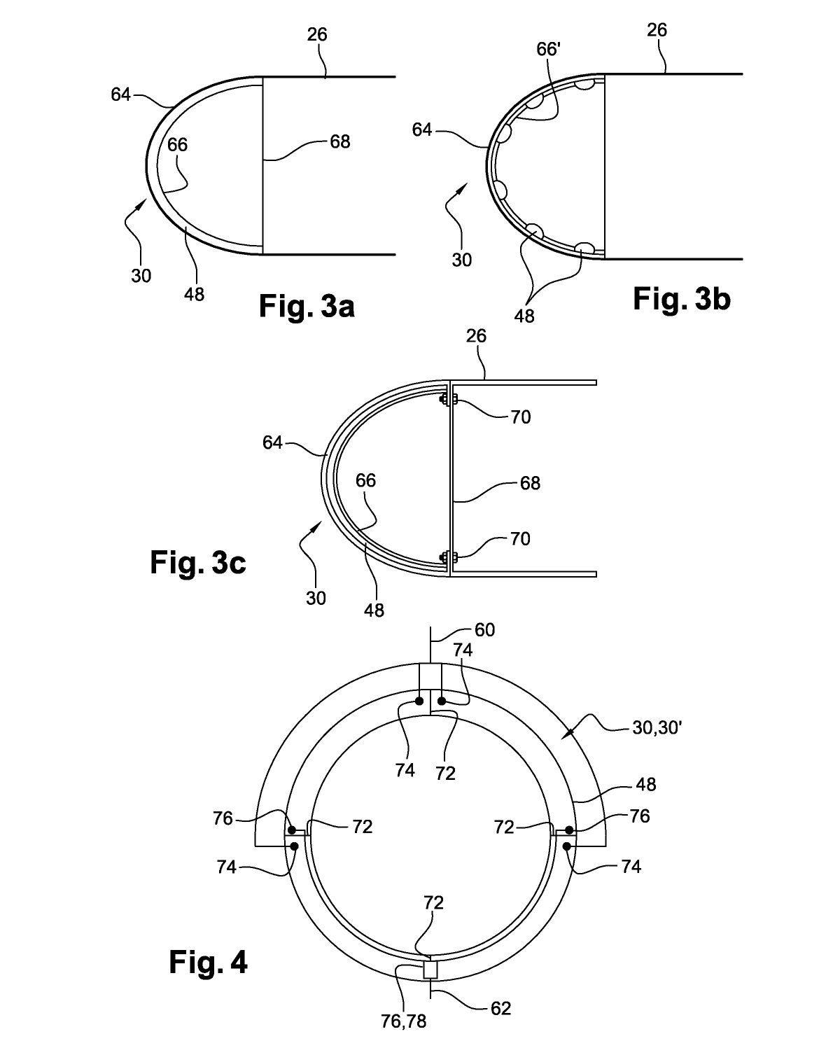

FIG. 3a shows a first embodiment of the air inlet lip 30. The air inlet lip 30 comprises two superimposed skins 64, 66 which are at a distance from one another so as to define therebetween a single de-icing channel 48 which extends over substantially the entire extent of the skins. The de-icing channel 48 is thus designed to ensure the circulation of a relatively thin film of heat transfer fluid between the skins 64, 66.

A first or outer skin 64 defines the outer surface of the air inlet lip 30. In the example shown, said skin has a substantially C-shaped cross section, the downstream, radially inner and outer circumferential edges of which are connected to upstream circumferential wall edges of the nacelle 26 respectively. The second or inner skin 66 also has a substantially C-shaped cross section. The above-mentioned edges of the walls of the nacelle 26 are interconnected by a transverse annular wall 68 which can be designed to hermetically seal the channel 48 in the region of the inner and outer peripheries of the skins 64, 66.

In the embodiment in FIG. 3a, the fluid can directly heat the entire outer skin 64 for the purpose of de-icing the lip 30.

FIG. 3b shows a variant of the air inlet lip 30 which also comprises in this case two superimposed skins 64, 66′.

The outer skin 64 is similar to that in FIG. 3a. The inner skin 66′ in this case is shaped to define, from the side of the outer skin 64, cavities which are closed by the outer skin 64 and which are intended to form independent de-icing channels 48.

Said cavities preferably have an annular shape so that the de-icing channels 48 are annular. The lip 30 comprises a plurality of de-icing channels, in this case six, which are designed to ensure the circulation of the heat transfer fluid between the skins 64, 66′.

The skins 64, 66, 66′ in FIGS. 3a and 3b can be made of sheet metal, the skin 66′ being able to be obtained by pressing a sheet of metal. The outer skin 64 can be of the reinforced type, for example by adapting the material of said skin or by increasing the mass density thereof. Generally, it is desirable for the outer skin 64 to be as resistant as possible to the impacts which may occur as a result of collision with foreign objects such as birds or hail, a comprise being sought between the resistance of the outer skin and the mass thereof. It may also be desirable for the outer skin 64 to deform as much as possible without cracking in the event of an impact, so as to prevent or limit the leak of heat transfer fluid which would result from the impact.

In the embodiment in FIG. 3b, the fluid directly heats portions of the outer skin 64, that is to say the portions which close the cavities in the inner skin 66, the rest of the outer skin being heated by conduction.

The variant in FIG. 3c differs from that in FIG. 3a in that the lip 30′ is detachable, that is to say that it is fixed to the walls of the nacelle 26 in a removable or detachable manner. For this purpose, the lip 30′ may comprise, in the region of each of the circumferential edges thereof, an annular flange for fixing, using means 70 of the screw and nut type, for example to the nacelle 26 and for example to the transverse wall 68 of the nacelle.

In the event of damage to the lip 30′, as a result for example of the impact of a foreign body such as a bird, said lip can easily be disassembled and replaced with a new one. The de-icing channel 48 is thus replaced since it is integrated in the lip 30′.

Reference is now made to FIG. 4, which shows an embodiment of the means for supplying heat transfer fluid to and draining off said fluid from the or each de-icing channel 48.

In the example shown, a single de-icing channel 48 is shown, said channel having a general annular shape and being divided into sectors or compartments. The channel 48 is thus formed of a plurality of sectors, in this case four, which are arranged circumferentially end to end around the axis of revolution of the channel. The channel sectors in this case have the same circumferential extent, which is substantially an angle of approximately 90°.

The channel sectors are separated from one another by substantially radial walls 72, of which there are four in the example shown, said walls being distributed regularly around the above-mentioned axis. Said walls 72 are located at 3 o'clock, 6 o'clock, 9 o'clock and 12 o'clock respectively, using the analogy of the dial of a clock.

The means for supplying heat transfer fluid form a portion of the outlet duct 60 at the outlet of the exchanger 46, and the means for draining off said fluid form a portion of the above-mentioned duct 62 which returns to the pump 50 for circulating the heat transfer fluid. Each channel sector comprises a fluid inlet 74 and a fluid outlet 76. The fluid inlet 74 of each channel sector is located in an upper portion of the sector, and the fluid outlet 76 thereof is located in a lower portion in such a way that the fluid can flow from the inlet to the outlet by means of gravity in the event that the pump 50 fails or stops. The fluid inlets and outlets in this case are located at the circumferential ends of the channel sectors.

The fluid outlets 76 of the two channel sectors located in the low portion are shared and comprise a collector 78 which is located substantially at 6 o'clock.

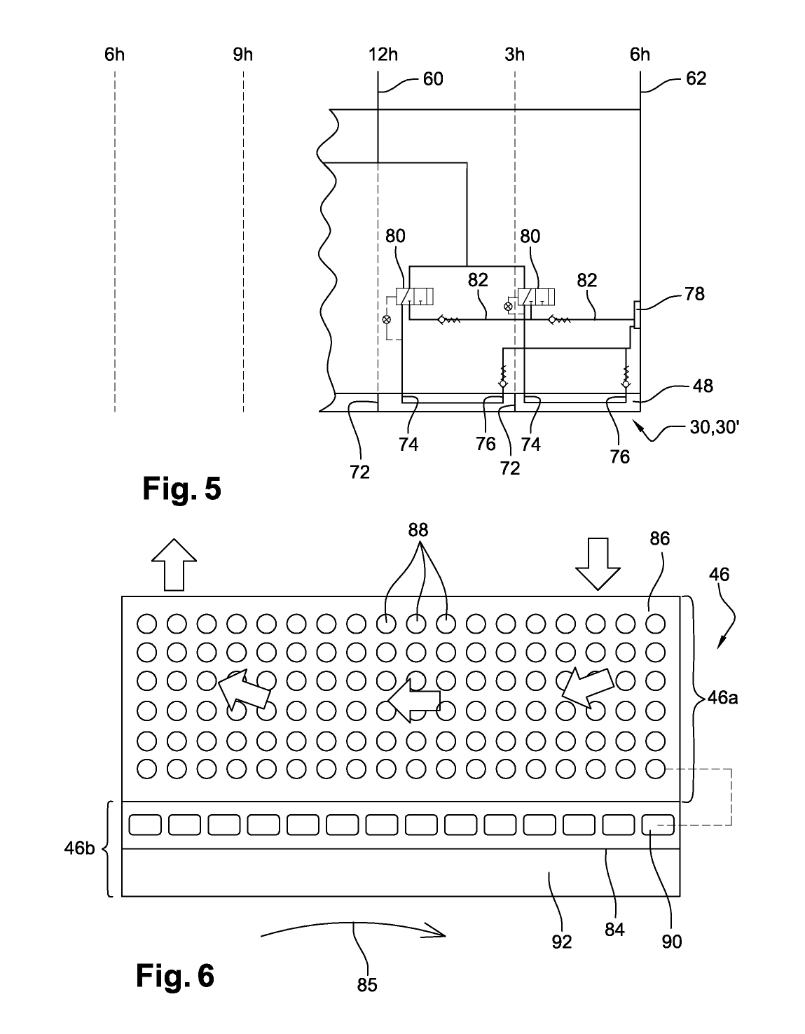

As shown schematically in FIG. 5, a valve 80 can be associated with each fluid inlet 74 in such a way that the supplies to the channel sectors can be controlled independently of one another. Advantageously, said valves 80 are bypass valves which can be controlled in order to bypass the heat transfer fluid directly from the duct 60 to the duct 62, without passing through the channel sectors (bypass ducts 82).

In the event of an impact of a foreign body on the lip, and of damage to the lip to the extent of causing a leak of heat transfer fluid in a channel sector, this system can make it possible to keep at least an undamaged portion of the channel sectors operational. In the event of a partial or total cut-off of the fluid circuit and/or in the event of a failure of the circuit, the valves 80 make it possible to create a diversion which transports the fluid back towards the collector 76 or the duct 62, without passing through the damaged region(s). The failure of the circuit can be detected by means of pressure sensors which are associated with the valves.

The oil system of the main circuit of the engine operation remains protected in the event of an impact of a foreign body on the lip or on another portion of the nacelle, the heat exchanger 46 of the de-icing circuit being positioned in the nacelle so as to not be damaged by such an impact. A leak of heat transfer fluid into at least one de-icing channel 48 could have the consequence of compromising the heat exchanges with the oil, and this can lead to insufficient cooling of the oil of the main circuit of the engine operation in some situations, such as during full thrust of the engine on take-off in hot weather. Nevertheless, the thrust of the engine can be reduced to decrease the cooling requirements of the oil. In the event of a leak of the heat transfer fluid, there is thus no risk of engine shut-down as a result of overheating and lack of lubrication as could be the case with a leak of oil from the main circuit.

It should be noted that, very preferably, the heat transfer fluid will be selected so as to be non-flammable, so that any leak of heat transfer fluid does not start a fire if fluid sucked into the air inlet reaches a high-temperature region of the engine. This limits the risk of engine fire in the event of an impact of a foreign body on the lip.

FIG. 6 shows a specific embodiment of the heat exchanger 46 of the de-icing circuit.

Said heat exchanger 46 in this case comprises two heat exchange modules, a first heat exchange module 46a which is equipped with the two above-mentioned circuits, primary and secondary respectively, for circulating oil and heat transfer fluid, and a second heat exchange module 46b of the surface type (for example a surface air cooled oil cooler—SACOC), said module 46b comprising an outer surface 84 which is intended to be swept by a flow 85 of cooling air.

The two modules 46a, 46b in this case are superimposed and formed of a plurality of layers or strata. The module 46a comprises a fluid circulation chamber 86 (cf. arrows), which is part of the secondary fluid circuit, and wherein oil circulation manifolds 88 extend, which are part of the primary oil circuit.

The module 46b comprises a chamber 90 for circulating oil which is inserted between the chamber 88 and the outer surface 84. Said surface 84 comprises projecting fins 92 which are intended to increase the surface areas for heat exchange with the air flow 85.

The manifolds 88 can be independent of the chamber 90. In a variant, a bypass system shown schematically by dotted lines can be put into place between the manifolds 88 and the chamber 90. Said bypass system is advantageously equipped with a valve. Said bypass can be operational permanently or only in specific cases. For example, in the case of hot weather or when the temperature of the oil or the air of the flow 85 is very high, or in the event of failures such as described previously, this bypass could be implemented to optimise heat exchanges.

The valve of the bypass system is advantageously a thermostatic valve. Said valve is preferably designed to open the bypass when the temperature of the oil exceeds a specific threshold.

In normal operation, the lubrication oil circulates in the circuit of the engine for the purpose of lubricating specific elements thereof. After lubricating the engine, the oil is recovered and cooled before being injected back into the tank 42. The cooling takes place by exchanging heat with the heat transfer fluid in the first module 46a and optionally with the air flow 85 in the second module 46b. The heat transfer fluid heated after passing into the first module 46a is driven by the pump 50 so as to circulate in the channels 48. The pump 50 can, in order to operate, benefit either from a mechanical drive installed for example in an accessory gear box (AGB), or an electrical system having a generator dedicated to the AGB or thus a system using the power provided by electricity generators. After circulating in the channels 48 and de-icing the lip 30, 30′, the fluid is cooled and can restart a new cycle of cooling the oil in the exchanger 46.

1. Propulsion assembly, comprising a turbine engine surrounded by a nacelle comprising an annular air inlet lip, the propulsion assembly further comprising a circuit for lubricating elements of the turbine engine and a circuit for de-icing the air inlet lip, wherein said de-icing circuit comprises a heat exchanger comprising two superimposed heat exchange modules, including:
a first heat exchange module comprising a primary circuit of oil supplied by said lubrication circuit and a secondary circuit of a heat transfer fluid for supplying at least one de-icing channel extending into said air inlet lip, said de-icing circuit further comprising a pump for circulating the heat transfer fluid into said at least one de-icing channel,
and a second heat exchange module of the surface type and comprising an outer surface which is intended to be swept by a flow of cooling air.

2. Propulsion assembly according to claim 1, wherein the lip comprises two skins which are superimposed and define said at least one channel therebetween.

3. Propulsion assembly according to claim 2, wherein one of the skins defines an outer surface of the lip.

4. Propulsion assembly according to claim 2, wherein the skins define a single de-icing channel therebetween, which channel has a relatively small thickness and is designed to ensure the circulation of a film of heat transfer fluid.

5. Propulsion assembly according to claim 2, wherein the skins define a plurality of independent de-icing channels therebetween, which channels are each designed to ensure the circulation of heat transfer fluid.

6. Propulsion assembly according to claim 5, wherein one of the skins comprises hollow portions which are closed by the other of the skins to define said de-icing channels.

7. Propulsion assembly according to claim 1, wherein the lip is fixed to the rest of the nacelle by detachable fixing means.

8. Propulsion assembly according to claim 1, wherein said at least one de-icing channel has a general annular shape and is divided into sectors, each channel sector being connected to an inlet and to an outlet of heat transfer fluid, which are independent of the inlets and outlets of heat transfer fluid of the other channel sectors.

9. Propulsion assembly according to claim 8, wherein the fluid inputs of the channel sectors are connected to the pump by valves.

10. Propulsion assembly according to claim 1, wherein the heat exchanger is coupled to a surface exchanger, an outer surface of which is intended to be swept by a flow of cooling air.

11. Propulsion assembly according to claim 1, wherein said first module comprises a first fluid circulation chamber, which is part of the secondary fluid circuit, and wherein oil circulation manifolds extend, which are part of the primary oil circuit.

12. Propulsion assembly according to claim 11, wherein said second module comprises a second oil circulation chamber which is inserted between said first chamber and said outer surface.

13. Propulsion assembly according to claim 1, wherein said outer surface comprises projecting fins which are intended to increase the surface areas for heat exchange with said air flow.

14. Propulsion assembly according to claim 11, wherein said manifolds are independent of said second chamber.

15. Propulsion assembly according to claim 11, wherein a bypass system connects the manifolds and said second chamber.

16. Propulsion assembly according to claim 15, wherein said bypass system comprises a valve.

17. Propulsion assembly according to claim 16, wherein said valve is a thermostatic valve.

18. Propulsion assembly according to claim 17, wherein said thermostatic valve is designed to open the bypass when the temperature of the oil exceeds a specific threshold.
